(19) United States
(12) Patent Application Publication
(10) Pub. No.: US 2007/0190496 A1
(43) Pub. Date: Aug. 16, 2007

(54) Furniture layout planning templates

(76) Inventor: Kristen Lamb, Woodland Hills, UT (US)

Correspondence Address: THORPE NORTH & WESTERN, LLP., 8180 SOUTH 700 EAST, SUITE 350, SANDY, UT, 84070, US

(21) Appl. No.: 11/706,754

(22) Filed: Feb. 14, 2007

Related U.S. Application Data
(60) Provisional application No. 60/773,533, filed on Feb. 14, 2006.

(51) Int. Cl. G09B 25/00

(52) U.S. Cl. 434/72

(57) ABSTRACT

A furniture position planning apparatus is disclosed for helping to plan the furniture layout for a room. The furniture position planning apparatus includes multiple two-dimensional furniture representations. These furniture representations represent the broadest projected footprints of different furniture items, and are capable of being folded to a compact size for storage.

Priority of U.S. Provisional patent application Ser. No. 60/773,533 filed on Feb. 14, 2006 is claimed.

### BACKGROUND

The present invention relates generally to residential and commercial interior layout planning. More particularly, the present invention relates to a plurality of two-dimensional, life-size furniture representations for aiding in the furniture layout process.

Furniture planning tools are currently in existence on the market for facilitating the planning of furniture layouts in homes, offices and a variety of other environments. These planning tools are used by homeowners, designers, and furniture retails desiring to create floor plans, organize, layout, and pre-select and/or pre-position furniture, before purchasing.

Historically, various scaled-down room representations have been used by individuals desiring an economic furniture/space planning tool. These representations feature a means of creating a small-scale representation of a room. Attachable furniture representations are then positioned within the room representation. While these planning aids provide for a quick and easy planning tool, they often have a narrow variety of furniture representations, often inaccurately representing the desired furniture sizes and shapes. When using a scaled-down room representation for furniture planning a user is forced to visualize how furniture will look or fit alongside architectural features of a room (such as, doors, windows, paneling, vents, and fireplaces), leaving room for error and misjudgment. Similarly, critical features of a room, such as, traffic patterns, room balance, and room focus are often difficult for a novice planner to effectively develop with only the aid of a scaled-down model. The threat of oversight and the potent inaccuracies in scaling down measurements frequently leads to miscalculations involving: door swing, window and room dimensions, and ultimately furniture selection.

In attempt to provide a more accurate and visual furniture planning tool, three-dimensional furniture representations are also available for furniture layout planning. These representations overcome many of the shortcomings involved with scaled-down representations, providing a physical representation that can be measured and placed inside the desired room. Due to their more costly nature however, these three-dimensional furniture representations often come in only a small variety of sizes and shapes, limiting their ability to represent actual furniture dimensions. Accordingly, some of these three-dimensional furniture representations have timely assembly procedure. Assembled representations are by nature bulky and difficult to position and re-position, as is frequently done in furniture layout planning. Further, the cost of a set of these three-dimensional representations may be large, leading to one-time-use rentals or borrowed equipment.

Virtual reality planning tool have also been created, allowing an individual to visualize and plan a room space without the hassle of bulky or expensive rentals. These virtual reality tools are not economically feasible for home and small business owners who desire a cost effective furniture planning solution.

### SUMMARY

Accordingly, it has been recognized that it would be advantageous to develop an economical, furniture planning aid, that is both life-size and that represents furniture of a wide variety of sizes that can be used by homeowners, designers, furniture retailers, and the like.

Briefly, and in general terms, the invention is directed to a set of 2-dimensional, life-size furniture representations for assisting in planning the furniture positioning of a room. These representations are sized to the broadest projected footprints of their respective furniture item in order to facilitate accurate measurements and furniture coordination. Further, these furniture representations are capable of being folded to a compact size for storage and transportation purposes.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a top view of a living room containing laid-out furniture representations in accordance with an embodiment of the present invention;

FIG. 2 is a perspective view of a foldable furniture representation and corresponding enclosure in accordance with one embodiment of the present invention;

FIG. 3 is a perspective view of a single, uncut sheet comprising multiple furniture representations for a living room according to one embodiment of the present invention; and

FIG. 4 is a perspective view of a single, uncut sheet comprising multiple furniture representations for a bedroom according to one embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

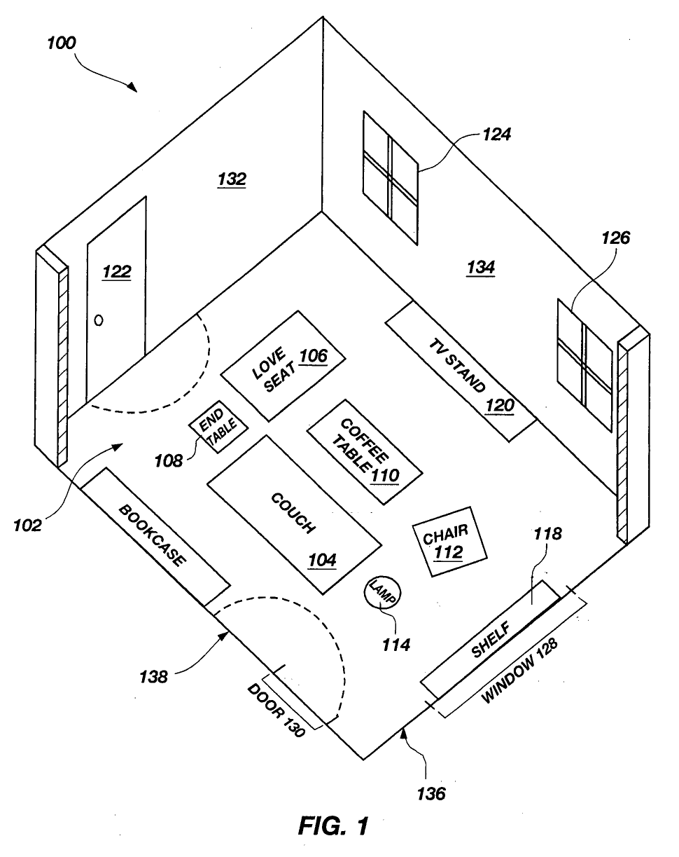

As illustrated in FIG. 1, an unfurnished room 100 contains multiple life size, planar furniture representations (104, 106, 108, 110, 112, 114, 116, 118, and 120) laid down on the floor surface 102, in an example implementation in accordance with the present invention. These representations represent the broadest projected footprint of different furniture items; meaning that they represent the entire area that a furniture item would cover at its maximum lengths and widths (this concept is equivalent to a top-view). For example, the broadest projected footprint of a simple, circular table, with simple vertical legs, would be a circle with a diameter equal to the diameter of the circular tabletop. This attribute improves a user's ability to correctly measure furniture sizes, preventing the purchase of furniture that will not fit in a desired space. The unfurnished room also contains four walls (132, 134, 136, and 138), two inward-opening doors (122 and 130), and three windows (124, 126, and 128).

It is to be noted that that the term “furniture item” or “furniture representation” includes a variety of furniture representations, accessory representations and other representations that can be used in a room layout. In this manner, dining table representations, conference table representations, credenza representations, plant representations, armoire representations, counter representations, workbench representations, floor mirror representations and other representation of objects that may be placed in a room by a homeowner, designer, or furniture retailer are meant by the term “furniture item” and “furniture representation”.

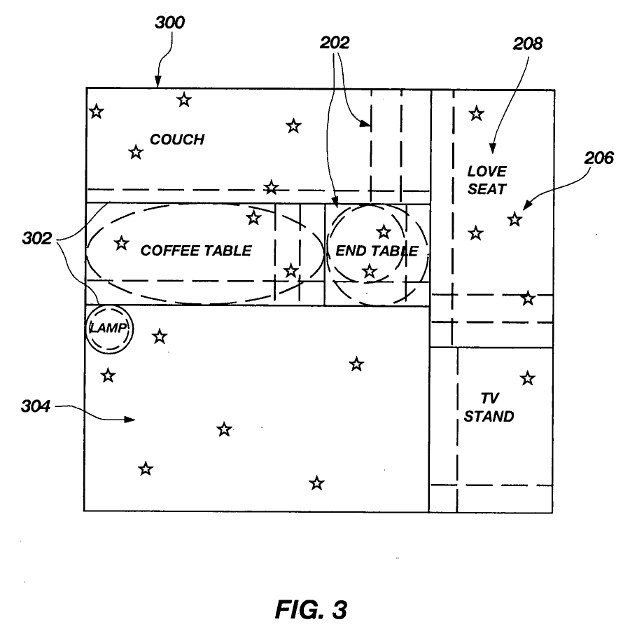

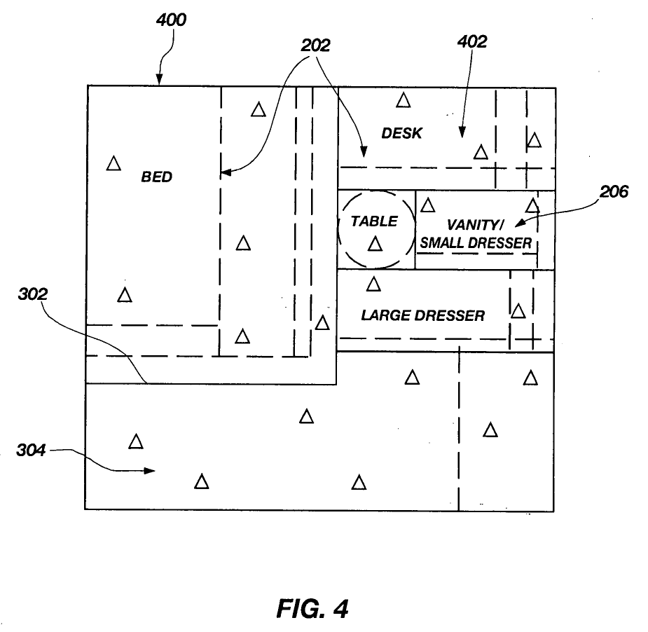

The furniture representations in the unfurnished room 100 are foldable, precut, individual representations that have been positioned by a user for the purpose of planning a furniture layout for this room. The term “precut” is used here to mean being factory-cut or being cut by a manufacturer, as opposed to the uncut representations that are represented in FIG. 3 and FIG. 4. A user has planned the seating arrangements for this unfurnished room by positioning a couch representation 104, a love seat representation 106, and a chair representation 112 near the center of the room. It is to be noted that the term “couch representation” also refers to a sofa representation, an upright futon representation, and the like. These representations are positioned to face a TV stand representation 120 that has been placed along a wall 134 between two windows (124 and 126). For convenience, a coffee table representation 110 has been placed in front of the couch, love seat, and chair representations. The couch representation is sided by an end table representation 108 and a lamp representation 114. Behind the couch representation a bookcase representation 116 has been positioned along the wall 138. Along another wall 136 and below a window 128, a shelve representation 118 has been placed. In this manner a furniture layout has been positioned in this room in order to assist in planning and visualizing a potential furniture layout.

As will be noted, the ability to preposition a furniture representation in a room assists to avoid incorrect measurements and improving layout effectiveness. As further illustrated in FIG. 1, a user can open door 122 after placing the end table 108 and love seat 106 representations down to verify that the door would not contact a end table or love seat. Similarly, by pre-positioning the TV stand representation, a user can note whether or not an actual TV stand would interfere with the two windows (124 and 126). In the same manner, a user will be able to walk common traffic pattern, view the balance and focus of a room, and coordinate whether certain furniture representations will interfere with the architectural features of a room.

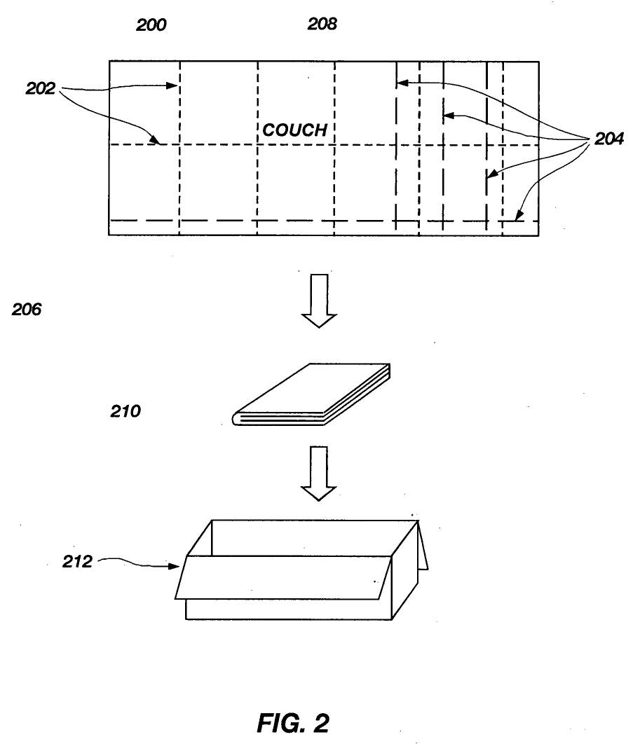

FIG. 2 shows, a precut furniture representation, 200 representing a couch, according to another implementation of the present invention. This representation is made of a foldable material, similar to those in FIG. 1. Typical foldable materials include various types of papers and plastics, fabrics, as well as with other material that could be practical to this invention. An identifier, 208 is printed on the foldable material, identifying the type of furniture item it represents. These identifiers can be text, representational images, or other identifiers that could be practical with this invention. These identifiers help to distinguish between representations having similar shapes and sizes.

The furniture representation 200 (or couch representation) contains various sizing marks 204 to assist in sizing the furniture representation to the desired dimensions. As illustrated, the couch representation has three vertical sizing marks, marked at typical couch lengths, for adjusting the representation to accurately reflect the user's couch length. A horizontal sizing mark is also illustrated for adjusting the width/depth of the couch to accurately reflect the user's couch widths. Typical couch dimensions are approximately 8′×3′6″, though it will be apparent that any set of dimensions could be practical with this invention. Typical sizing marks may mark be spaced at 3 inch increments (this value may be proportionally larger or smaller depending on various furniture types, and as apparent with other practical uses of this invention), and would provide for a furniture representation of several sizes larger and smaller than a typical furniture size. These length adjustments may be made by cutting or folding the couch representation.

Each set of furniture representations include multiple representations of various furniture items. These sets may include furniture items for various rooms, such as but not limited to, a living room, a dining room, a kitchen, an office, and a bedroom. Likewise, furniture representations can represent furniture for a sitting room, an office workspace, a game room, a piano room, a laundry room, a bathroom and other rooms that will be practical to this invention. In order to distinguish furniture representations of one room from those of another, a visual graphic format 206 is included on the respective furniture representations. Visual graphic formats may be a color distinction, a repeated design (as with the repeated star graphic in FIG. 2, 3 and the repeated triangle graphic of FIG. 4), a graphic pattern, or other graphic formats that will be apparent for use with this invention.

To facilitate in folding, scored lines 202 can be incorporated into the furniture representation 200. These scored lines are designed to facilitate the folding of the furniture representations for easy storage. This process is illustrated in FIG. 2, where the couch representation 200, having scored lines, is folded into a compact size 210. This folded couch representation is then inserted into an enclosure, which is capable of holding multiple folded furniture representations. In this manner, the furniture representations can be folded into a relatively small size, enclosed and stored for future use. This attribute allows for repeated use of the same product when remodeling, repositioning, or relocation is desired or needed.

The enclosure 212 is part of a kit, according to one aspect of the present invention. This enclosure may be a box, a paper or plastic envelope, or zip lock type plastic bag, or any other enclosing means that will be practical for use with this invention. The enclosure is of sufficient size to hold a multiple folded furniture representation. Kits may include furniture representations for planning the furniture layout of multiple rooms, or a kit may contain the furniture representations for a single room only. Along with containing multiple furniture representations a kit can include an instruction sheet. This instruction sheet can give instructions for the unfolding, positioning, and sizing of the contained furniture representations. Similarly, an instruction sheet may contain furniture layout tips or training instruction to help a user to more quickly and effectively plan a suitable furniture room layout. The kit may also include a measuring tape to assist in measuring furniture and room dimensions, and/or scissors.

FIG. 3 and FIG. 4, illustrate a single, uncut sheet of foldable material, including multiple furniture representations, according to another implementation of the present invention. Scored lines (not shown), sizing marks 202, identifiers 208, and a visual graphic format 206 are included in this sheet similar to previously described embodiments. While these sheets illustrate furniture representations of a given room, furniture representations for multiple rooms may be included on a single sheet, in accordance with the present invention.

FIG. 3 illustrates a single, uncut sheet 300 of foldable material, which includes multiple furniture representations for a living room layout, according to another implementation of the present invention. The multiple representations included in this single, uncut sheet include: a couch representation, a love seat representation, an end table representation, a coffee table representation, a TV stand representation, and a lamp representation, and a blank representation 304. Individual furniture representations can be cut along furniture representation dividing lines 302. Once cut, these furniture representations may be sized according to the manner previously described. It is to be noted that the furniture item representation, are representative of the type of furniture item representations that can be represented on an uncut sheet. But, the inclusion of this example is not intended to limit the scope of the invention in any way.

Occasionally, users may own or plan to purchase non-typically sized furniture or furniture that is not be represented on an uncut sheet (for example, the bookcase 116 and shelf 118 representations of FIG. 1 are not represented on the uncut sheet of FIG. 3). In this case, a precut furniture representation lack some desired furniture item representations. For this and other reasons, a blank representation 304 can be included on the uncut sheet. This blank representation is of sufficient size so that multiple small representations or one or multiple large representations may be cut from it. Using this blank representation along with the other described representations of the uncut sheet, a user can effectively and quickly produce a complete set of full-scale furniture representations for living room layout planning.

FIG. 4 illustrates a single, uncut sheet 400 of foldable material, which includes multiple furniture representations for a bed room layout, according to another implementation of the present invention. The multiple representations included in this single, uncut sheet include: a bed representation, a desk representation, a table representation, a vanity/small dresser representation, a large dresser representation, and a blank representation 304. The blank representation can be used in the manner previously described. Thus, using this sheet, a user can effectively and quickly produce a complete set of full-scale furniture representations for bedroom layout planning.

Summarizing and reiterating to some extent, benefits of the present invention include a plurality of foldable, life size, planar representations of broadest projected footprints of different furniture items. Various implementations of life size, planar furniture representations are available for a variety of rooms, offices, buildings and houses. The compact, life size representation provides an economical, easy-to-use tool for planning and visualizing a furniture layout. Sizing marks and blank representations improve the accuracy of representational sizing, and provide for a potentially wide range of furniture representational capabilities.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An apparatus for planning furniture positioning within a room, comprising:
a plurality of life-size, planar representations of broadest projected footprints of different furniture items, said representations being foldable to a compact size for storage.

2. The apparatus of claim 1, wherein the representations have an identifier, identifying a type of the furniture item.

3. The apparatus of claim 1, wherein the representations have scored fold lines to assist with folding.

4. The apparatus of claim 1, wherein the representations have various sizing marks to assist in creating representations of desired sizes.

5. The apparatus of claim 1, wherein the representations have a visual graphic format to distinguish representations of one room from the representations of another room.

6. The apparatus of claim 1, wherein the plurality of representations are included in a kit, comprising an enclosure and an instruction sheet.

7. The apparatus of claim 1, wherein the room is a living room and the representations includes at least a sofa representation, a chair representation, and a coffee table representation.

8. The apparatus of claim 1, wherein the room is a bedroom and the representations include at least a bed representation and a dresser representation.

9. The apparatus of claim 1, further comprising a blank representation of sufficient size so that multiple smaller representations can be cut from the blank representation.

10. The apparatus of claim 1, wherein the representations are made of either paper, fabric, or plastic.

11. An apparatus for planning furniture positioning within a room, comprising:
a plurality of life-size, planar representations of the broadest projected footprints of different furniture items customary for a given room, said representations being foldable to a compact size for storage;
each representation having an identifier, identifying a type of the furniture items.

12. The apparatus of claim 11, further comprising a blank representation of sufficient size so that multiple smaller representations can be cut from the blank representation.

13. The apparatus of claim 11, wherein the representations have scored fold lines to assist with folding.

14. The apparatus of claim 11, wherein the representations have various sizing marks to assist in creating representations of desired sizes.

15. The apparatus of claim 11, wherein the representations have a visual graphic format to distinguish representations of one room from the representations of another room.

16. The apparatus of claim 11, wherein the plurality of representations are included in a kit, comprising an enclosure and an instruction sheet.

17. The apparatus of claim 11, wherein the room is a living room and the representations includes at least a sofa representation, a chair representation, and a coffee table representation.

18. The apparatus of claim 11, wherein the room is a bedroom and the representations include at least a bed representation and a dresser representation.

19. The apparatus of claim 11, wherein the representations are made of either paper, fabric, or plastic.

20. A graphic system for enabling the planning of furniture item positioning in a room, comprising:
a plurality of individual, life-size, planar representations of the broadest projected footprints of furniture items, said representations being foldable to a compact size for storage;
each representation having an identifier, identifying a type of the furniture item.
